(19) United States
(12) Patent Application Publication
(10) Pub. No.: US 2023/0309756 A1
(43) Pub. Date: Oct. 5, 2023

(54) Condiment Dispenser

(71) Applicant: H.J. Heinz Company Brands LLC, Pittsburgh, PA (US)

(72) Inventors: Gregg Leech, Wigan (GB); Kim Bertens-Vlems, Berkel-Enschot (NL); Ivi Kalyvioti, Utrecht (NL)

(21) Appl. No.: 18/017,303

(22) PCT Filed: Jul. 23, 2021
(86) PCT No.: PCT/US2021/042915

§ 371 Date: Jan. 20, 2023

Related U.S. Application Data
(60) Provisional application No. 63/056,173, filed on Jul. 24, 2020.

(51) Int. Cl. A47J 47/01; F04B 53/10

(52) U.S. Cl. CPC A47J 47/01; F04B 53/1037

(57) ABSTRACT

A condiment dispensing pump system is provided that includes a valve chamber and a valve retainer having a first portion defining a valve cavity and a second portion for coupling to an inlet flow path. A one-way valve is removably insertable into the valve cavity. The one-way valve includes a tether portion coupled to the second portion of the valve retainer such that the one-way valve is removable from the valve cavity while still tethered to the valve retainer. The condiment dispensing pump system includes a spout having a first end fluidly coupled to the valve cavity and a second end opposite the first end. A dispensing nozzle is removably attached to the second end of the spout, the dispensing nozzle being tethered to the spout tube such that when the dispensing nozzle is detached from the second end of the spout the dispensing nozzle remains tethered to the spout tube.

### CROSS REFERENCE TO RELATED APPLICATIONS

This application claims the benefit of U.S. Provisional Application No. 63/056,173, filed Jul. 24, 2020, which is hereby incorporated herein by reference in its entirety.

### FIELD

This disclosure relates to fluid dispensing devices and, in particular, to condiment dispensing devices.

### BACKGROUND

Restaurants often provide customers with one or more condiments for their food items. These condiments include, as examples, ketchup, mustard, mayonnaise, and barbeque sauce. Some restaurants provide large containers of one or more condiments along with a hand pump that is actuated to dispense the condiment to the user for use with their food.

Current hand pump solutions are difficult to clean. This is in part due to the long passageways that are difficult to reach along with the many internal crevices and ledges within the pump components and containers. Employees are often reluctant to clean current hand pump solutions due to the difficulty of doing so. Moreover, disassembling the pump may result in the loss of one or components, particularly the small components, during cleaning. As a result, the pumps are not cleaned as often, and, even when cleaned, the pump may not be fully cleaned. Thus, current pump solutions are prone to contamination.

### BRIEF DESCRIPTION OF THE DRAWINGS

FIG. 1 is a top perspective view of a condiment dispensing device including a manual pump.

FIGS. 2A-C are front elevation, side elevation, and top plan views, respectively of the condiment dispensing device of FIG. 1.

FIG. 3 is an exploded view of the condiment dispensing device of FIG. 1 shown without the manual pump.

FIG. 4 is a top perspective view of a manual pump for use with the condiment dispensing device of FIG. 1 according to a first embodiment.

FIG. 5A is an exploded view of the manual pump of FIG. 4.

FIG. 5B is a top perspective view of a cap of the manual pump of FIG. 4.

FIG. 5C is a top perspective view of a sealing collar of the manual pump of FIG. 4.

FIG. 5D is a top perspective view of a guide ring of the manual pump of FIG. 4.

FIG. 6A is a cross-section view of the manual pump of FIG. 4 in a resting configuration taken along lines 6A-6A of FIG. 4.

FIG. 6B is a cross-section view of the manual pump of FIG. 4 in a depressed configuration taken similarly to FIG. 6A.

FIGS. 7A-B are a bottom perspective and side elevation views, respectively of a connection between a valve retainer and a chamber body of the manual pump of FIG. 4.

FIG. 8 is a top perspective view of the manual pump of FIG. 4 disassembled for cleaning.

FIG. 9 is a top perspective view of a manual pump for use with the condiment dispensing device of FIG. 1 according to a second embodiment.

FIG. 10 is an exploded view of the manual pump of FIG. 9.

FIG. 11A is a front elevation view of the manual pump of FIG. 9.

FIG. 11B is a cross-section view of the manual pump of FIG. 9 taken along lines A-A of FIG. 11A.

FIG. 11C is an enlarged view of a portion of the pump of FIG. 9 as shown in FIG. 11B.

FIG. 12 is a cross-section view of the pump of FIG. 9 installed in a container of the condiment dispensing device of FIG. 1.

FIG. 13 is a top cross-section view of the pump of FIG. 9 attached to the container of the condiment dispensing device of FIG. 1.

FIG. 14 is a top perspective view of a valve retainer of the pump of FIG. 9.

FIG. 15 is a top perspective view of a dispensing tip of the pump of FIG. 9.

FIGS. 16-21 show cross-sections of various components of the pump of FIG. 9 being cleaned.

Elements in the figures are illustrated for simplicity and clarity and have not necessarily been drawn to scale or to include all features, options or attachments. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

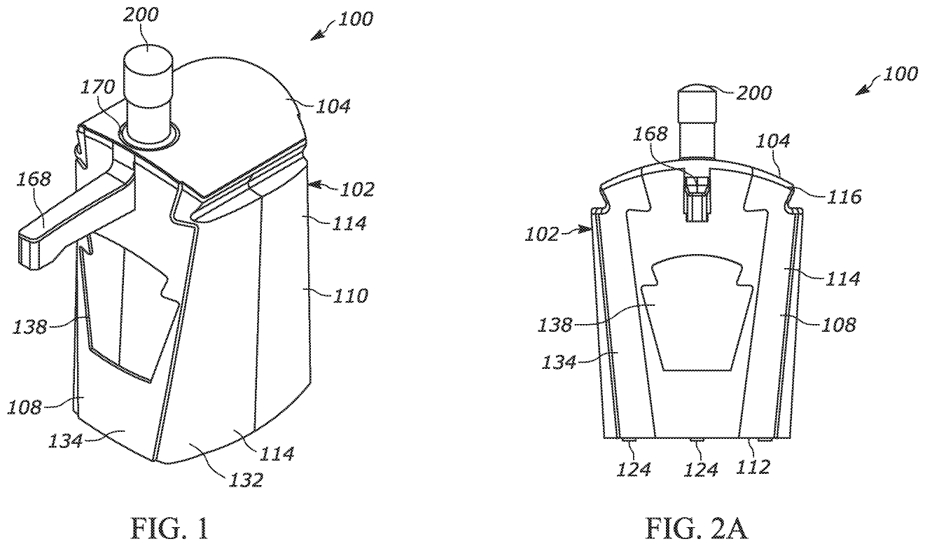

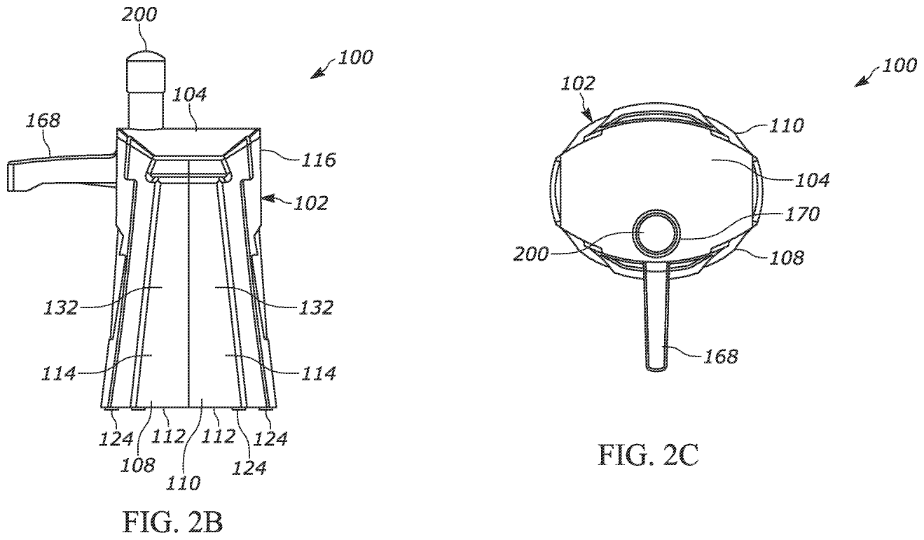

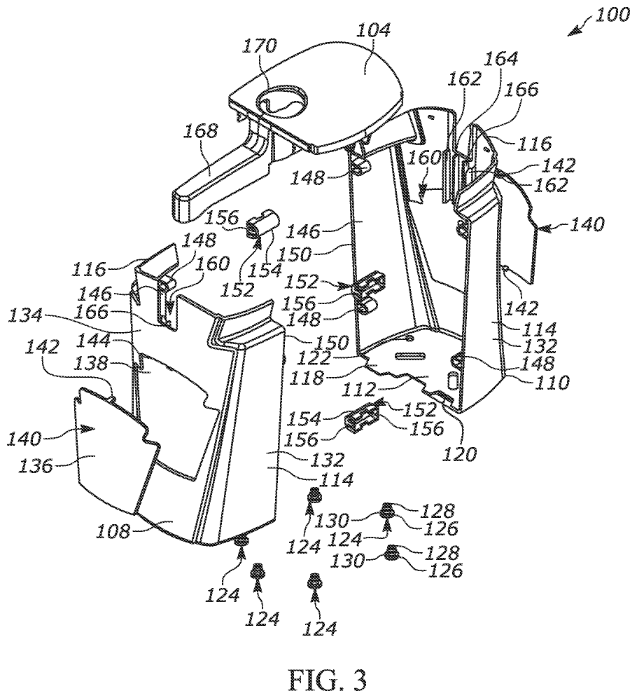

With reference to FIGS. 1-2C a condiment dispensing device 100 is shown. The condiment dispensing device 100 includes a housing, such as a container body 102, a lid 104, and a manual pump system, such as pumps 200, 400 discussed below. With reference also to FIG. 3, the container body 102 includes a first portion 108 and a second portion 110. The first portion 108 is configured to connect to the second portion 110 to form the container body 102 into which the condiment (e.g., a condiment pouch containing a condiment) may be placed. In the embodiment shown, the first and second portions 108, 110 each make up one half of the container body 102. In other embodiments the portions 108, 110 may each form a different amount of the container body 102 and also have different shapes. The first and second portions 108, 110 may be made of a plastic, for example, acrylonitrile butadiene styrene (ABS). The first and second portions 108, 110 each include a base 112, walls 114 extending substantially vertically from the base 112, and a rim 116 at the top of walls 114. The rear edge 150 of the base 112 may include a tab 118 and a recess 120 for receiving the tab 118 of the opposite portion 108, 110. The tab 118 may have a barb configuration with an angled tip disposed on the end thereof for engaging the recess 120 of the opposite portion 108, 110. The tab 118 may be deflectable such that the projection deflects as it contacts the base 112 of the opposite portion and snaps back to its original position when the angled tip is positioned in the recess 120 of the opposition portion 108, 112. The tab 118 and recess 120 configuration may aid to secure the rear edges 150 of the first and second portions 108, 110 to one another.

The base 112 further includes a plurality of holes 122 through the base for attaching feet 124. The feet 124 may be made of a rubber or soft material. When installed on the bottom of the container body 102, the feet 124 may aid to prevent the condiment dispensing device 100 from sliding along the surface on which it is placed, e.g., a countertop or table. The feet 124 may also prevent the base 112 of the condiment dispensing container 112 from scratching or damaging the surface. The feet 124 may each include a base portion 126 and a head 128 connected to the base portion 126 by a neck 130. The head 128 is sized to be larger than the holes 122 of the base 112. The heads 128 of the feet are forced through the holes 122 in the base 112 until the neck 130 is positioned within the hole 122. Since the head 128 is larger than the hole 122, the head 128 is not able to pass back through the hole 122 thereby securing the feet 124 to the base 112. To remove the feet 124 from the holes 122, the head 128 of the feet 124 are forced back through the holes 122. When inserted into the base 112, the base portion 126 of the feet 124 extend between the base 112 and the surface on which the container body 102 is placed.

The walls 114 of the first and second portions 108, 110 of the container body 102 include an external surface 132 having a front surface 134 for attaching or displaying a label 136. The label 136 may include information indicating the brand and/or the type of condiment that is within the container body 102. The label 136 may be a paper or plastic label that is affixed to the front surface 134 by an adhesive. In the embodiment shown, the front surface 134 includes a recess 138 for receiving a label bracket 140. The label bracket 140 includes a front surface that includes a label 136 as described above. The label bracket 140 includes attachment arms 142 at the upper and lower portions for engaging holes 144 in the recess 138 of the container body 102. The attachment arms 142 include an angled tip having a barb configuration such that the angled tip engages and edge of the hole 144 and deflects the attachment arms 142 until the angled tip has passed through the hole 144. The attachment arms 142 then return to their original position such that a hook of the angled tip engages the edge of the hole 144 preventing the label bracket 140 from being withdrawn without deflecting the attachment arms 142. The exterior of the container body 102 may have a color that corresponds to a certain condiment type. For example, red for ketchup, yellow for mustard, maroon for barbeque, cream white for mayonnaise, etc.

The internal surface 146 of the walls 114 of the first and second portions 108, 110 of the container body 102 include loops 148 disposed along the rear edge 150 of the first and second portions 108, 110 of the container body 102. With the rear edge 150 of the first and second portions 108, 110 adjacent one another, the loops 148 of the first and second portion 108, 110 are aligned. An end of a clip 152 may be positioned over the loops 148 of the first and second portions 108, 110 that are adjacent one another to attach the first and second portions 108, 110 together. The clips include a curved body 154 that is curved to correspond to the shape of the loops 148. Each end of the clip 152 includes a projection 156 having a barbed tip that is configured to hook the inside of the loops 148 of both the first and second portion 108, 110 of the container body 102.

Thus, to attach the first and second portions 108, 110 together, the rear edges 150 of the first and second portions are brought into alignment with one another. The loops 148 may also be aligned with one another. The tab 118 of the first portion is inserted into the recess 120 of the second portion 110 and the tab 118 of the second portion 110 is inserted into the recess 120 of the first portion 108. The clip 152 is then positioned over a loop 148 of the first portion 108 and a loop 148 of the second portion 110 that are aligned and adjacent to one another. The clip 152 is positioned such that the barbed projection 156 engages the ends of the loops 148. Force is then applied to the clip 152 to cause the barbed projections 156 to deflect outward over the loops 148. Once the barbed projection 156 passes into the interior of the loop 148, the barbed projection 156 elastically returns to its initial position. A clip 152 is placed over each of the loops 148 of the first and second portions 108, 110. The clips 152 aid in securing the first portion 108 to the second portion 110 to create the container body 102.

A condiment may be disposed within the container body 102. In one example, a pouch or bag containing the condiment is disposed within the container body 102. The condiment may be any condiment including, as examples, tomato ketchup, mustard, barbeque sauce, mayonnaise, relish, spiced curry ketchup, spiced curry gewurz, sweet mustard, frites sauce, cocktail sauce, garlic sauce, salad dressing, and tartar sauce.

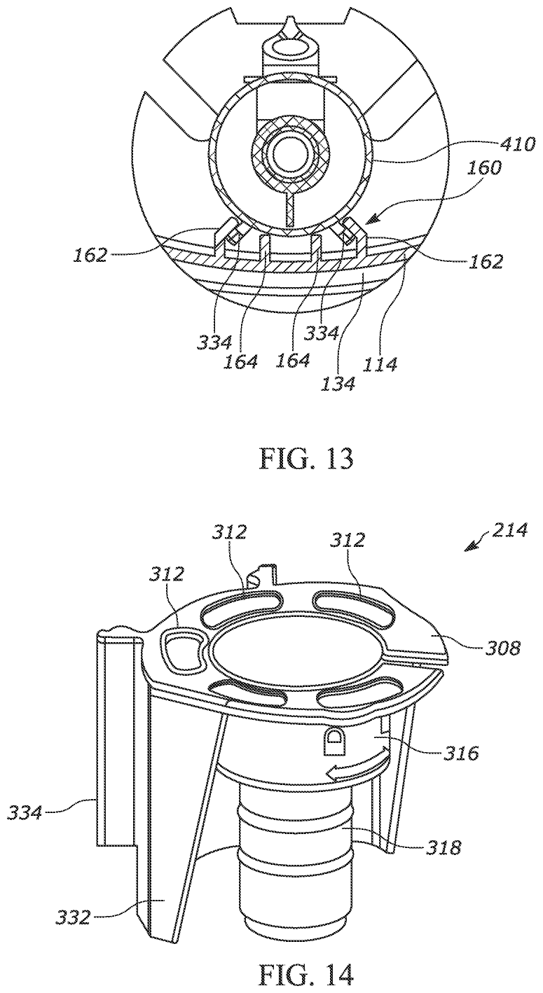

The internal surface 146 of the first and second portions 108, 110 of the container body 102 further includes ribs 160 extending internally therefrom. The ribs 160 are used to attach the pump 200, 400 to the container body 102. With reference to pump 400 of FIG. 13, the ribs 160 are shown to attach the pump 400 to the container body 102. As shown, the outer ribs 162 of the first and second portion 108, 110 angle towards one another. The pump 400 includes complementary ribs 334 extending longitudinally along a surface of the valve retainer 214. The complementary ribs 334 are similarly angled. When attaching the pump 400 to the container body 102, an end of the complementary ribs 334 of the pump 400 are aligned with the outer ribs 162. The ribs 334 of the pump 400 are then slid along the internal surface 146 of the container body 102 with the ribs 334 of the pump 400 positioned within the outer ribs 162 of the container body 102. The surfaces of the ribs 162, 334 engage one another and provide sufficient friction to hold the pump 400 in place relative to the container body 102. The pump 200, 400 may be detached from the container body 102 by forcibly moving the pump 200, 400 along the ribs 162 in the opposite direction of insertion. The internal ribs 164 may contact the surface of the pump 400 to provide support and prevent the pump 400 from wobbling. The internal ribs 164 may also force the pump 400 away from the internal surface 146 such that the ribs 334 of the pump 400 are forced against the outer ribs 162 thereby increasing the frictional engagement between the ribs 162, 334. While the example above described the attachment of pump 400, pump 200 also includes complementary ribs 334 and may be similarly attached to the container body 102.

The rim 116 of the first and second portions 118 of the container body 102 may each include a notch 166 for a spout cover 168 of the lid 104 to pass through. Including a notch 166 in both the first and second portions 118 allows the lid 104 to be attached in multiple orientations, i.e., with the spout cover 168 extending through the notch 166 of the first portion 108 or through the notch of the second portion 110. The rim 116 supports the lid 104 when the lid 104 is placed on the top of the container body 102. The lid 104 may be attached to the rim 116 of the container body 102 by a push fit. The rim 116 of the first and second portions 118 may include one or more projections or bumps on the internal surface 146 that a portion of the lid 104 hooks or engages when pushed onto the container body 102 to secure the lid 104 to the container body 102.

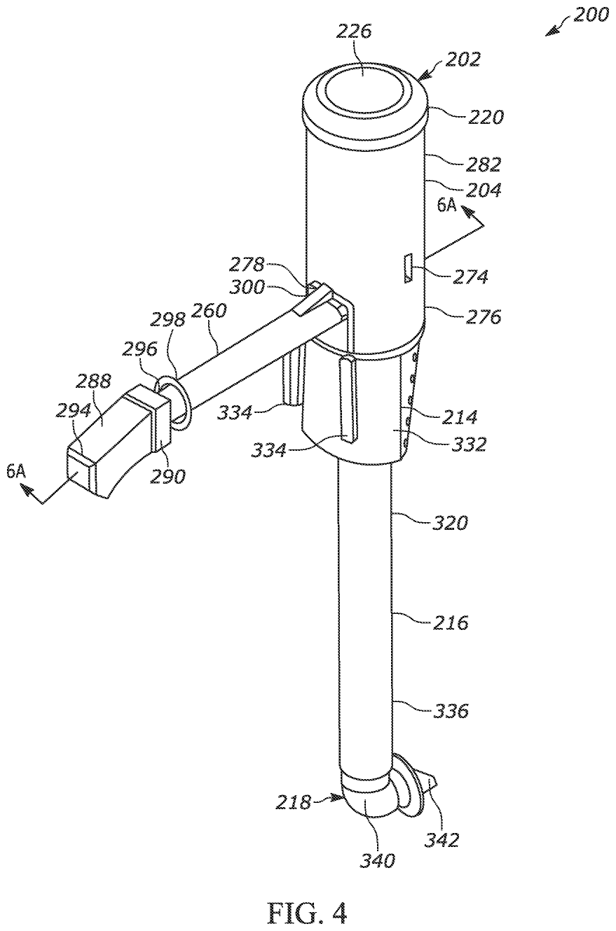

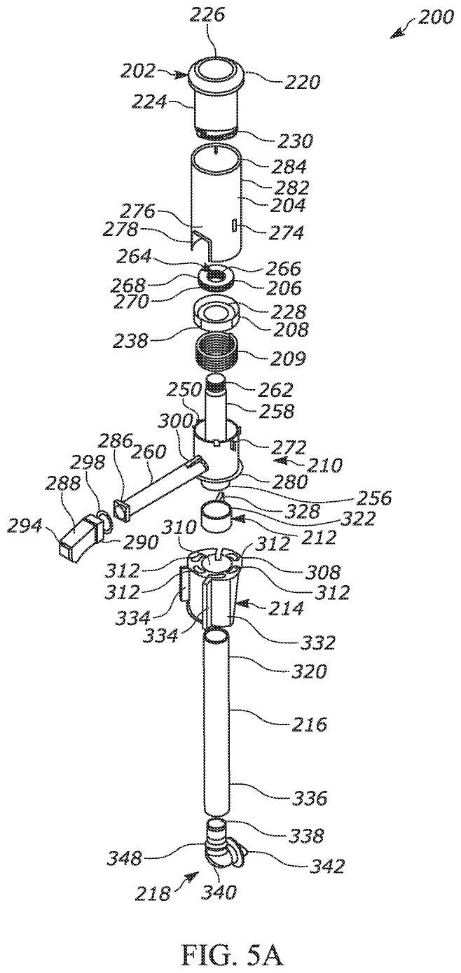

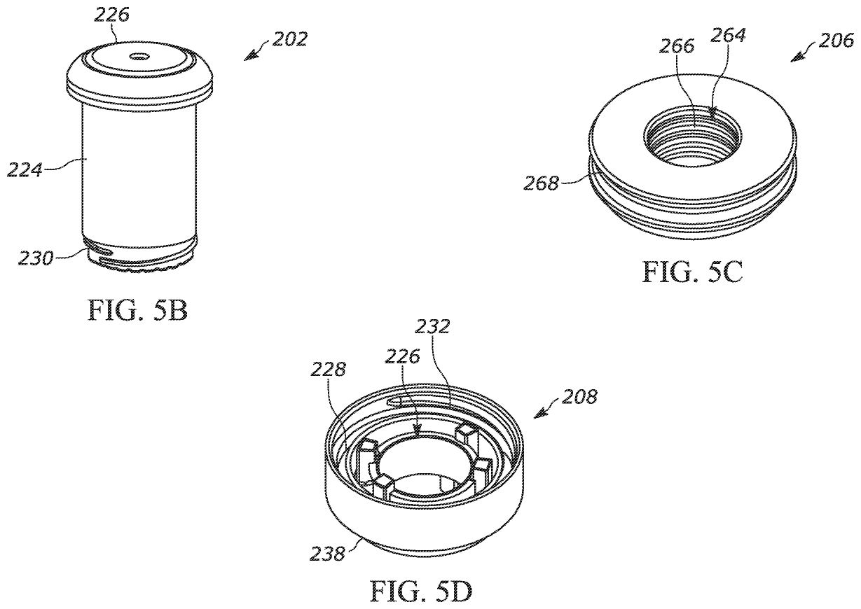

The lid 104 includes a body 169 defining a hole 170 extending therethrough. The body 169 of the lid 104 covers the opening of the container body 102 formed by the rim 116 of the first and second portions 108, 110. This prevents items from entering the container body 102, for example, dust and other particles in the air. The lid 104 also closes the container body 102 so that the internal components of the condiment dispensing device 100 are not viewable to a user. When the lid 104 is placed on the container body 102, the hole 170 provides an opening into the container body 102 for a portion of the pump 200, 400 to pass through. The spout cover 168 extends from the body 169. When the lid 104 is placed on the container body 102, the spout cover 168 is aligned with a notch 166 of the container body 102 and extends outward from the container body 102. The spout cover 168 of the lid 104 is a cover for the spout 260, 412 of the pump 200, 400. Providing a cover for the spout 260 of the pump 200, 400 reduces the chances of contact by a user with the spout 260, 412 of the pump 200, 400 carrying the condiment. The spout cover 168 also protects the spout 260, 412 of the pumps 200, 400 from impact that may crack or damage the spout 260, 412 of the pumps 200, 400. The spout cover 168 also aids to prevent a user from contacting the dispensing tip 288 of pump 200 or the dispensing end 436 of pump 400, which may reduce the spread of germs, bacteria, and the like to the next user of the condiment dispensing device 100. The lid 104 may be made of a plastic, for example, ABS. With reference to FIGS. 4-8 the manual pump 200 includes a pumping cap 202, a sleeve 204, a sealing collar 206, a guide ring 208, a spring 209, a chamber body 210, a valve 212, a valve retainer 214, a dip tube 216, and a bag piercer 218.

The chamber body 210 includes a cylindrical wall 250 extending upward from a base 252 forming a valve chamber. The base 252 is a disk defining a hole 254 through the center thereof. An annular wall 256 extends downward from the base 252 about the hole 254. A pump chamber or air tube 258 extends upward from the base 252 about the hole 254. It should be appreciated that the air tube 258 may include or be filled with condiment and/or air and forms a pump chamber into which air and condiment may be drawn into through the valve 212 and forced out of along the spout 250 during pumping cycles. The spout 260 is a tube that extends laterally from a side of the base 252. The base 252 of the chamber body 210 includes a passageway 261 extending laterally through the base 252 that connects the spout 260 to the hole 254 that extends longitudinally through the base 252. The spout 260 extends substantially perpendicularly to the air tube 258. The spout 260 may be formed integrally or as a single piece with the air tube 258. The chamber body 210 may be made of a plastic, for example, polypropylene.

The end of the air tube 258 opposite the base 252 includes threads 262 disposed thereon for attaching to the sealing collar 206. The sealing collar 206 is a disk having a hole 264 through the center thereof. The hole 264 includes threads 266 disposed therein complementary to the threads 262 of the air tube 258. The sealing collar 206 may thus be threaded onto the end of the air tube 258. The sealing collar 206 includes an annular recess 268 extending about the radial edge of the sealing collar 206 for receiving a seal 270, such as a gasket or an O-ring. The sealing collar 206 may be made of a plastic, for example, polypropylene.

The cylindrical wall 250 includes projections 272 that extend radially outward from the cylindrical wall 250 for attaching to the sleeve 204. The sleeve 204 is substantially cylindrical and includes holes 274 therethrough for receiving the projection 272 of the chamber body 210. A first end 276 of the sleeve 204 is positioned around the cylindrical wall 250 of the chamber body 210. The first end 276 includes a notch 278 that aligns with the spout 260. The sleeve 204 may be made of a plastic, for example, polypropylene. To attach the sleeve 204 to the chamber body 210, the first end 276 of the sleeve 204 is aligned with the cylindrical wall 250 of the chamber body 210. The first end 276 is slid downward over the cylindrical wall 250 such that the cylindrical wall 250 is within the sleeve 204. The sleeve 204 is rotated to align the notch 278 with the spout 260 of the chamber body 210. The sleeve 204 is slid downward over the cylindrical wall 250 until the projections 272 of the cylindrical wall 250 snap into the holes 274 of the sleeve 204, thereby securing the sleeve 204 to the chamber body 210. The chamber body 210 may also include an annular rib 280 extending radially from the base 252 of the chamber body 210 to which the first end 276 of the sleeve 204 abuts when the sleeve 204 is attached to the chamber body 210.

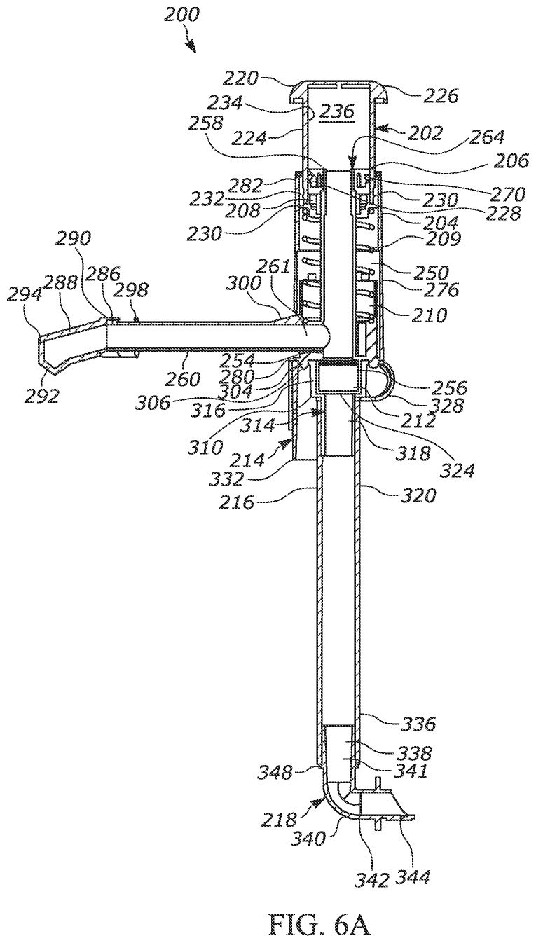

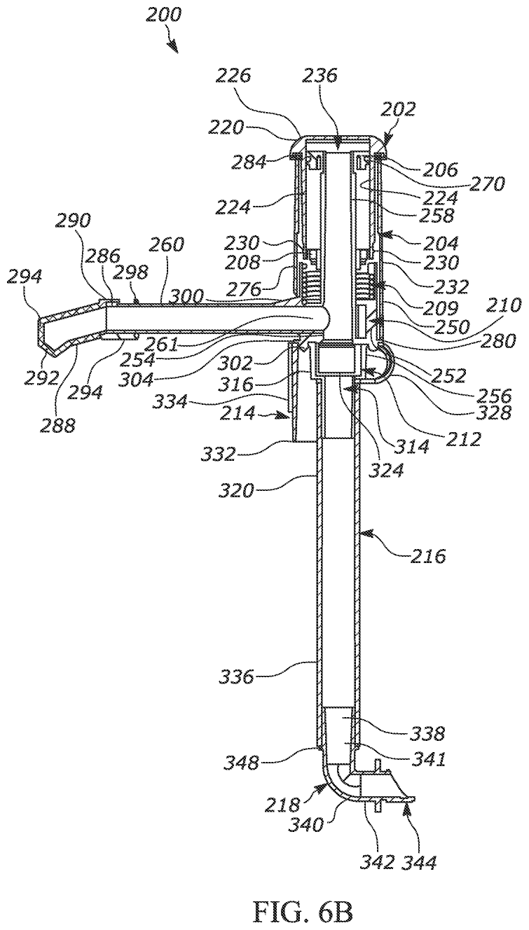

The second end 282 of the sleeve 204 receives a portion of the cap 202. The cap 202 includes a base portion 220 and a sleeve portion 224 extending from the base portion 220. The base portion 220 may include a rounded top 226 against which a user presses to actuate the pump 200 and dispense the condiment. The sleeve portion 224 is cylindrical and sized to be inserted within the second end 282 of the sleeve 204. The base portion 220 of the cap 202 has a diameter greater than the internal diameter of the second end 282 of the sleeve 204 such that the base portion 220 is not able to enter the sleeve 204. The cap 202 may be made of a plastic, for example, polypropylene. The end of the sleeve portion 224 opposite the base portion 220 includes the guide ring 208 affixed to the end thereof. The guide ring 208 has a disk shaped body with a hole 226 through the center thereof for receiving the air tube 258 of the chamber body 210. The guide ring 208 thus extends between the air tube 258 and the sleeve 204. The guide ring 208 defines an annular recess 228 about the hole 226 for receiving the end of the sleeve portion 224 of the cap 202. The annular recess 228 may be sized such that when the sleeve portion 224 is inserted therein, the walls forming the annular recess 228 clamp or grip the sleeve portion 224 to retain the sleeve portion 224 by a friction fit. In the embodiment shown, the annular recess 228 includes threads 232 for receiving threads 230 disposed on the end of the sleeve portion 224 opposite the base 220 of the cap 202. The sleeve portion 224 may then be screwed onto the guide ring 208. In another example, the end of the sleeve portion 224 of the cap 202 includes an annular rib that snaps into an annular groove within the annular recess 228 of the guide ring 208 (see FIGS. 6A-B). The guide ring 208 may be made of a plastic, for example, polypropylene.

An internal surface 234 of the sleeve portion 224 of the cap 202 engages the sealing collar 206 affixed to the end of the air tube. The seal 270 of the sealing collar 206 extends from the sealing collar 206 and contacts the internal surface 234 of the sleeve portion 224 of the cap 202. The seal 270 thus forms an airtight seal between the sleeve portion 224 and the sealing collar 206. As the cap 202 travels into and out of the sleeve 204, the seal 270 remains in contact with the internal surface 234 of the sleeve portion 224. The cap 202 and the sealing collar 206 thus create an air cavity 236 above the end of the air tube 258. With reference to FIGS. 6A-B, as the cap 202 is moved downward toward the configuration shown in FIG. 6B, the volume of air within the air cavity 236 is decreased, forcing air down the air tube 258 which increases the pressure within the chamber body 210. As the cap 202 is moved upward, the volume of air within the air cavity 236 is increased, drawing air up the air tube 258. This reduces the pressure within the chamber body 210.

The second end 282 of the sleeve 204 may include an annular rib 284 extending radially inward for retaining the guide ring 208 within the sleeve 204. As the cap 202 is withdrawn from the sleeve 204, the guide ring 208 is brought into contact with the annular rib 284 and the sealing collar 206, preventing the guide ring 208 from exiting the second end 282 of the sleeve 204. Thus, when the guide ring 208 is attached to the sleeve portion 224 of the cap 202, the cap 202 may not be withdrawn from the sleeve 204.

The spring 209 extends between the base portion 252 of the chamber body 210 and a lower surface 238 of the guide ring 208. The spring 209 is positioned such that the spring 209 extends about the air tube 258 and is contained by the sleeve 204. The spring 209 biases the cap 202 into an upward position where the guide ring 208 contacts the sealing collar 206. A user may apply a downward force to the cap 202 to compress the spring 209, for example, by pressing the cap downward with their hand. When the user removes the force (e.g., removes their hand from the cap), the spring 209 forces the cap 202 upward until the guide ring 208 contacts the sealing collar 206.

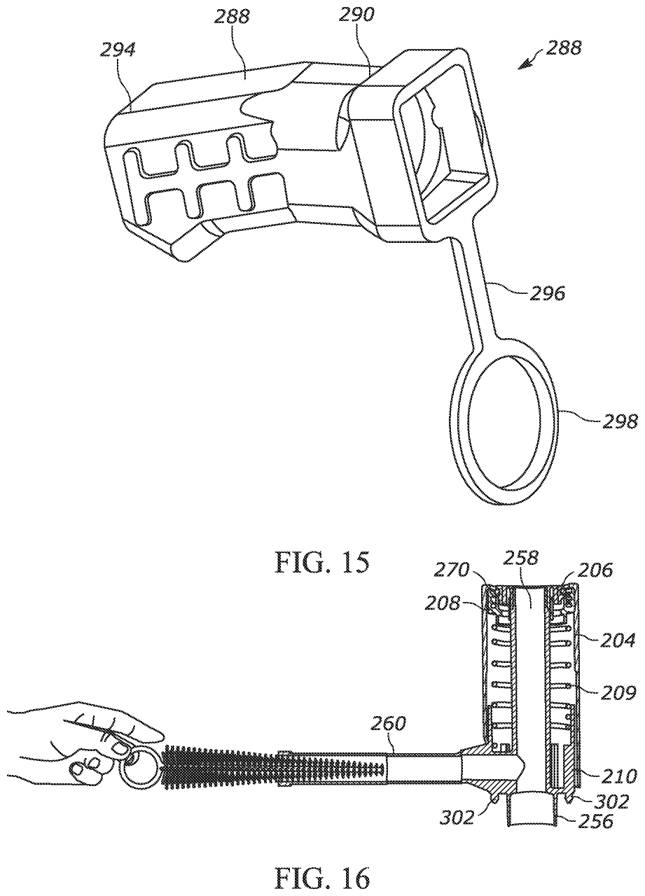

The end 286 of the spout 260 opposite the cylindrical wall 250 attaches to a dispensing nozzle, such as dispensing tip 288 (see FIG. 15). The dispensing tip 288 includes a first end 290 for attaching to the end 286 of the spout 260. The first end 290 may slide or be stretched over the end 286 of the spout 260. The dispensing tip 288 may be formed of a soft material, such as rubber for example. In other examples, the dispensing tip 288 may be made of a thermoplastic elastomer. Thus, once the first end 290 is slid and/or stretched over the end 286 of the spout 260, the first end 290 may contract and grip the end 286 of the spout 260 to attach the dispensing tip 288 thereto. In the embodiment shown, the end 286 of the spout 260 flares radially outward to form a square cross-sectional shape. In other embodiments, the end 286 may flare outward to form other cross-sectional shapes, e.g., circular. The first end 290 of the dispensing tip 288 may be complementarily shaped to fit over the end 286 of the spout 260. The dispensing tip 288 includes an internal passageway 290 extending along the length of the dispensing tip 288 for guiding the condiment toward the dispensing hole 292 on the second end 294 of the dispensing tip 290. The dispensing tip 288 may angle downward from the spout 260 to aid in guiding the condiment downward as the condiment exits the dispensing hole 292. Forming the dispensing tip 288 from a soft material allows the dispensing tip 288 to flex which may aid to prevent the dispensing tip 288 and/or spout 260 from breaking or cracking off when the dispensing tip 288 contacted by a user or brought into contact with another object. The dispensing tip 288 also may include a tether 296 that attaches to the spout 260. The tether 296 may include a flexible ring 298 that is positioned about the shaft of the spout 260. The flexible ring 298 may be sized such that it does not pass over the flared end 286 of the spout 260 without a user manually stretching the ring 298 to remove the dispensing tip 288. Thus, the tether 296 connects the dispensing tip 288 to the spout 260 even when the first end 290 of the dispensing tip 288 is not attached to the end 286 of the spout 260. Tethering the dispensing tip 288 to the spout 260 aids to prevent the dispensing tip 288 from becoming lost or separate from the other components of the pump 200 when the pump 200 is disassembled and/or cleaned.

Support flanges or arms 300 may extend from the base 252 of the chamber body 210 to the spout 260 to provide additional support to the spout 260. This structural support may aid in preventing the spout 260 from breaking off or cracking when the spout 260 is contacted by a user or brought into contact with another object.

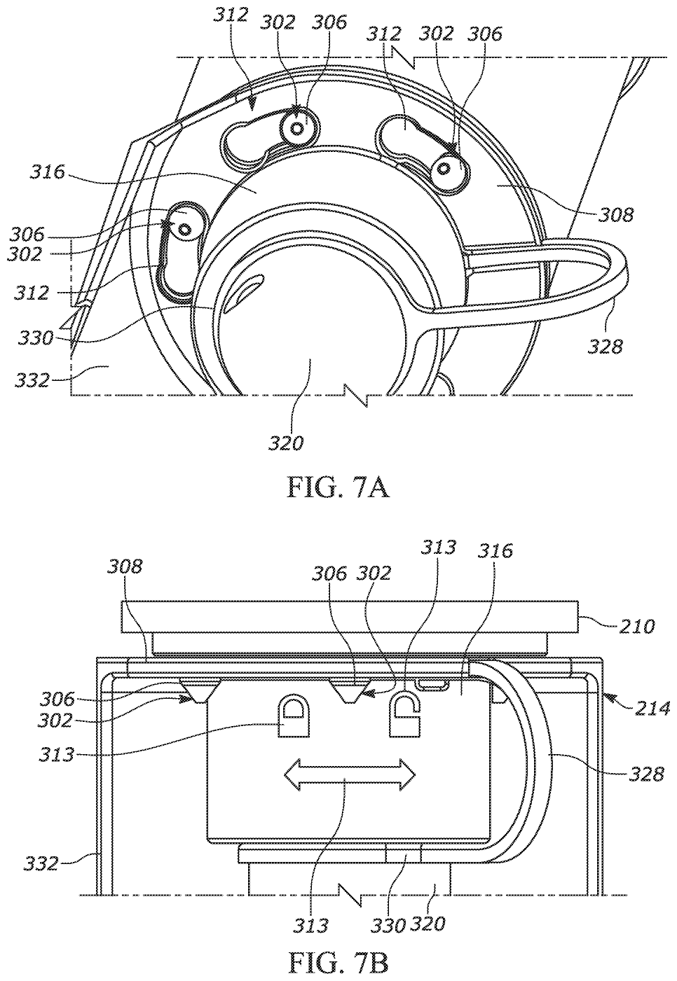

With reference to FIGS. 7A-B and 14, the base 252 of the chamber body 210 may also include protrusions 302 extending downwardly from the lower surface 303 for attaching to the valve retainer 214. The protrusions 302 include a neck 304 extending from the base 252 with a head 306 disposed on the end thereof. The head 306 has a larger diameter than the neck 304. The valve retainer 214 includes an attachment disk 308 defining a valve cavity or central hole 310 and a plurality of keyhole slots 312 extending therearound. The large end of the keyhole slots 312 are sized to allow the heads 306 of the protrusions 302 to pass through, but the smaller end of the keyhole slots 312 do not allow the heads 306 of the protrusions 302 to pass through. To connect the chamber body 210 to the valve retainer 214, the heads 306 may be inserted through the large end of the keyhole slots 312. The chamber body 210 and the valve retainer 214 may then be rotated relative to one another to bring the neck 304 of the protrusions within the smaller end of the keyhole slots 312, thereby securing the chamber body 210 to the valve retainer 214. As shown in FIG. 7B, the valve retainer 214 may include indicia 313 disposed thereon for indicating to a user which direction to rotate the valve retainer 214 relative to the chamber body 210 to lock the components together or to unlock the components from one another.

A tube portion 314 extends from the attachment disk 308. The tube portion 314 includes a large diameter portion 316 for receiving the valve 212 and a small diameter portion 318 for attachment to the inlet flow path, such as dip tube 216. The smaller diameter portion 318 may be inserted into an upper end 320 of the dip tube 216. The smaller diameter portion 318 may be sized to attach to the upper end 320 the dip tube 216 by a friction push fit. In another example, the upper end 320 of the dip tube 216 includes one or more holes 321 therethrough. The smaller diameter portion 318 of the valve retainer 214 may include a protrusion extending radially outward from the smaller diameter portion may be aligned with the holes of the dip tube 216 to attach the dip tube 216 to the valve retainer 214. The valve retainer 214 may be made of a plastic, for example, polypropylene.

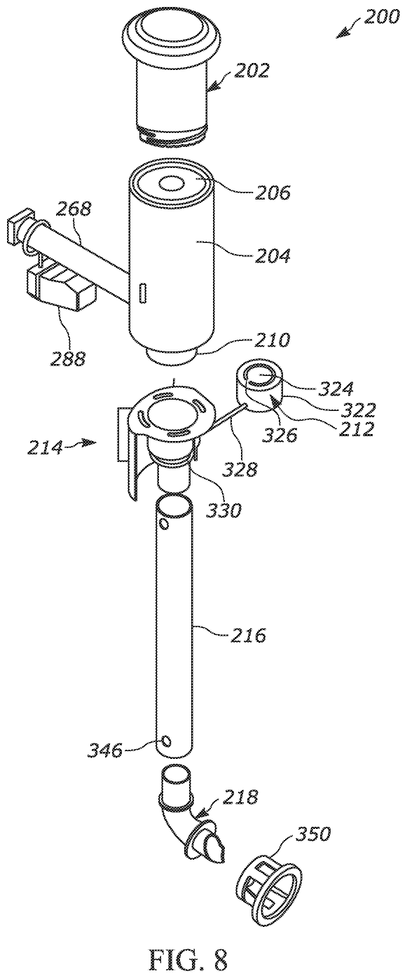

The large diameter portion 316 is sized to receive the valve 212 and the annular wall 256 of the chamber body 210 therein. The valve 212 may be inserted into the valve cavity or central hole 310 of the attachment disk 308 and the large diameter portion 316 to move the valve 212 into an installed position from a removed position. The walls forming the central hole 310 may be substantially smooth to permit the central hole 310 to be easily cleaned when disassembled. The valve 212 may be inserted until the valve 212 contacts the small diameter portion 318. The annular wall 256 of the chamber body 210 may be sized to fit within the valve 212 and prevent the valve 212 from moving substantially within the large diameter portion 316 when the chamber body 210 is connected to the valve retainer 214. The valve 212 is a one-way valve that allows fluid (e.g., the condiment) to pass upward through the tube portion 314 of the valve retainer 214, but does not allow the fluid to pass downward through the tube portion 314. As shown in FIG. 8 for example, the valve 212 is includes a cylindrical wall 322 sized to be inserted within the large diameter portion 316 of the valve retainer 214.

The valve 212 includes a flap 324 attached to the cylindrical wall 322 by a living hinge 326. When the flap 324 is downward, the valve 212 is closed and does not allow fluid to pass through. When the flap 324 is rotated upward, the valve 212 is open and fluid may pass through the opening formed between the flap 324 and the cylindrical wall 322 of the valve. The flap 324 is configured to rotate upward about the hinge 326 when fluid (e.g., the condiment) or the vacuum within the chamber body 210 force the flap 324 to rotate upward. The flap 324 rotates back downward to its original closed position when no force is applied to the flap 324 (i.e., it is normally closed) or when air or fluid pressure within the chamber body 210 forces the flap 324 back downward, closing the valve 212. The valve 212 may include a tether 328 and a ring 330. The ring 330 may be positioned about the small diameter portion 318. The valve 212 may be made of a plastic, for example, low-density polyethylene (LDPE). The ring 330 may be formed of a flexible material that must be stretched to position the ring 330 about the small diameter portion 318 of the valve retainer 214. Thus, the ring 330 contracts about the small diameter portion 318, gripping the smaller diameter portion 318 to tether the valve 212 to the valve retainer 214. The valve 212 thus remains affixed to the valve retainer 214 even when moved to the removed position outside of the central hole 310 from the installed position, for example, for cleaning.

The valve retainer 214 further may include a partial annular skirt 332 for connecting the valve retainer 214 and the pump 200 to the container body 102. The partial annular skirt 332 depends downwardly from an edge of the attachment disk 308 of the valve retainer 214. Two ribs 334 extend outwardly from the partial annular skirt 332 at an angle. The ribs 334 engage with the outer ribs 162 to attach the pump 200 to the container body 102, as described above in regard to FIG. 13.

The dip tube 216 is a tube that extends downward from the valve retainer 214 and toward the bottom of the container body 102. Extending the dip tube 216 near to the bottom of the container body 102 allows the lower end 336 to be positioned near the bottom of a condiment pouch where the condiment within the pouch gravitates toward. This may aid in more fully extracting the condiment from the condiment pouch, eliminating waste. The lower end 336 of the dip tube 216 attaches to the bag piercer 218. The dip tube 216 may be made of a plastic, for example, LDPE.

The bag piercer 218 is a rigid component including a first end 338 for attaching to the lower end 336 of the dip tube 216, a curved body 340, and a second end 342 including an angled tip 344 for inserting into the condiment pouch. The bag piercer 218 may be made of a plastic, for example, polypropylene. The first end 338 of the bag piercer 218 may be inserted into lower end 338 of the dip tube 216. The first end 338 may form a friction fit with the dip tube 216 to secure the bag piercer 218 to the dip tube 214. In another example, the lower end 338 of the dip tube include holes 346. The first end 338 of the bag piercer 218 may include one or more protrusions extending radially outward therefrom that are aligned with the holes 346 of the lower end 336 of the dip tube 216 to attach the dip tube 216 to the bag piercer 218. The first end 338 of the bag piercer 218 may include an annular rib 348 against which the lower end 336 of the dip tube 216 may abut to prevent the bag piercer 218 from being over inserted into the dip tube 216.

The curved body 340 of the hag piercer 218 extends between the first end 338 and the second end 342. The curved body 340 defines a passageway 341 through the hag piercer 218 from the first end 338 to the second end 342. The second end 342 includes the angled tip 344 that is configured to be inserted into the pouch or bag containing the condiment. Once the pouch has been pierced, the condiment may flow or be drawn from the pouch and into the passageway 341 of the hag piercer 218. The second end 342 may be configured to operate in conjunction with a port 350 of the pouch of the condiment. The second end 342 may include an annular disk configured to engage the pouch or the port 350 to provide a sealed connection with the bag piercer 218 and to prevent the bag piercer 218 from extending too far into the pouch or bag of the condiment.

In operation, the second end 342 of the bag piercer 218 is inserted into the pouch containing the condiment. The pouch and the pump 200 may be positioned within the container body 102. The pump 200 may be attached to the container body 102 via the ribs 162, 334 as described above. The sleeve 204 and/or the cap 202 may be inserted through the hole 170 of the lid 104 and the lid 104 placed on the rim 116 of the container body 102, such that the spout cover 168 of the lid 104 extends over the spout 260 and dispensing tip 288 of the pump 200. The cap 202 may then be pressed downward toward the lid 104. Moving the cap 202 downward forces air within the air cavity 236 of the cap 202 down the air tube 258. This momentarily increases the pressure within the chamber body 210. Because the valve 212 is closed, air cannot exit the chamber body 210 through the valve retainer 214 and the dip tube 216. The air is thus forced out the spout 260 and dispensing tip 288 of the pump 200. As the cap 202 is released or downward force on the cap 202 is withdrawn, the spring 209 forces the cap 202 back upward increasing the volume in the air cavity 236 of the cap 202. This increase in volume within the air cavity 236 draws air up the air tube 258 thereby reducing the pressure within the chamber body 210. This reduction in pressure opens the flap 324 of the valve 212 and draws air and/or the condiment up the dip tube 216. Initially after attaching the bag piercer 218 to the condiment pouch, only air may be drawn through the valve 212 as the condiment is withdrawn from the pouch and into the bag piercer 218 and dip tube 216.

After the cap 202 has been pressed downward and released one or more times, the condiment may be drawn upward and through the one-way valve 212. Once the condiment has been drawn into the chamber body 210, pressing the cap 202 downward increases the pressure in the air tube 258 which increases the pressure within the chamber body 210. Since the condiment cannot travel downward beyond the one-way valve 212 the condiment is forced out of the chamber body 210 through the spout 260. Once the condiment reaches the end 286 of the spout 260, the condiment enters the dispensing tip 288. The condiment travels along the passageway 290 of the dispensing tip 288 and is dispensed out of the dispensing hole 292 to the user.

As described above, the pump 200 is able to dispense condiments of all varieties having different viscosities and densities. The pump 100 may dispense approximately 30 g of fluid each time the cap 202 is pressed downward.

After all or a substantial portion of the condiment within the condiment pouch has been withdrawn from the condiment pouch, the condiment pouch may be replaced or refilled. The bag piercer 218 may be attached to the new or refilled condiment pouch and the process above may be restarted.

After a certain period of use, the pump 200 may need to be cleaned. With reference to FIG. 8, the pump 200 may be disassembled into groups for cleaning. For instance, the groups of components of the pump 200 may be placed in a dishwasher or may be hand washed. Configured as described above, the pump 200 may quickly and intuitively be disassembled and reassembled. The bag piercer 210 may be withdrawn from the condiment pouch and the first end 338 may be removed from the lower end 336 of the dip tube 216, for example, by applying a force to pull the first end 338 of the bag piercer 218 from the dip tube 216. The upper end 320 of the dip tube 216 may be removed from the small diameter portion 318 of the valve retainer 214, for example, by applying a force to pull the first end of 338 of the dip tube 216 away from the valve retainer 214.

With reference to FIGS. 7A-B, the valve retainer 214 may be rotated relative to the chamber body 210 to move the heads 306 of the protrusions 302 toward the larger ends of the keyhole slots 312. The valve retainer 214 and the chamber body 210 may then be pulled apart from one another.

The valve 212 may be pulled out of the valve cavity or hole 310 in the attachment disk 308 of the valve retainer 214 and remain tethered to the small diameter portion 218 of the valve retainer 214. Keeping the valve 212 tethered to the valve retainer may prevent the valve 212 from becoming misplaced during cleaning.

The dispensing tip 288 may be removed from the end 286 of the spout 260, for example, by pulling and/or twisting the dispensing tip 288 off of the end 286 of the spout 260. The dispensing tip 288 may remain tethered to the spout 260 during cleaning as this may prevent the dispensing tip 288 from becoming misplaced as the pump 200 is cleaned.

The cap 202 may be detached from the guide ring 208. For example, the cap 202 may be pulled with force to snap the annular rib 230 of the sleeve portion 224 of the cap 202 out of the annular groove 232 within the annular recess 228 of the guide ring 208. In other examples, the cap 202 may be unscrewed from the guide ring 208.

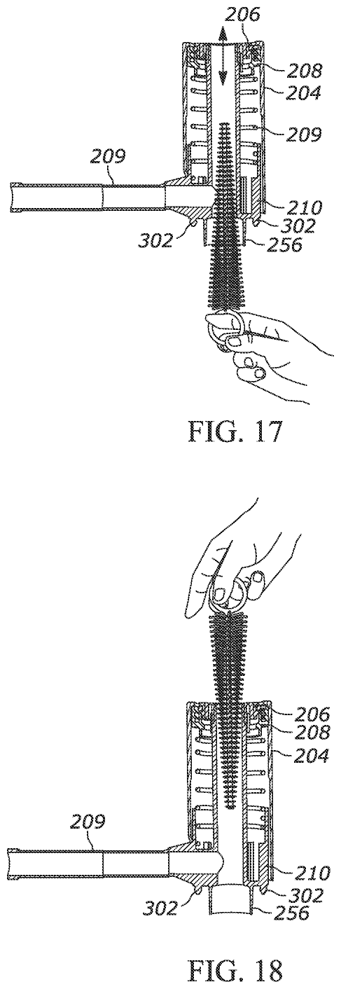

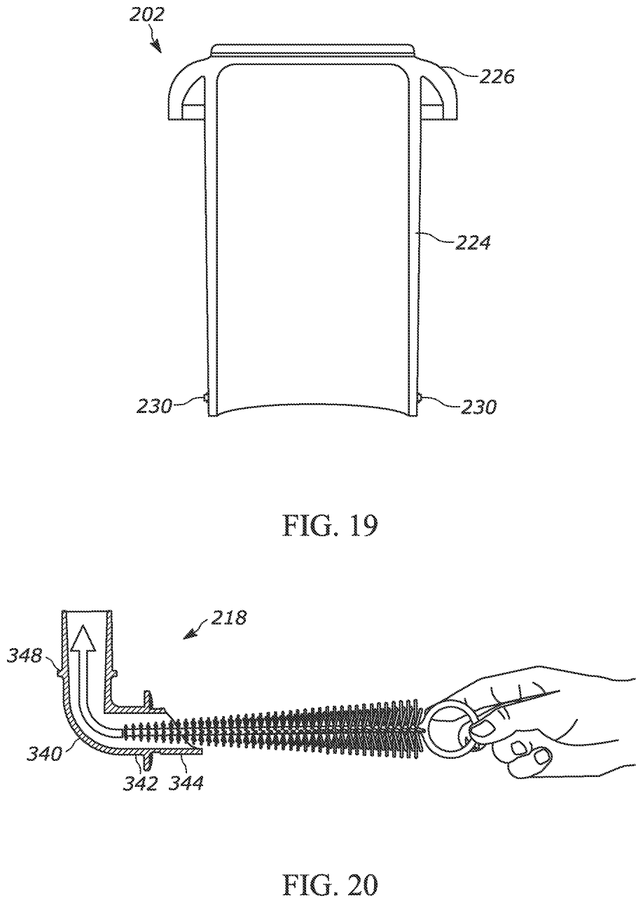

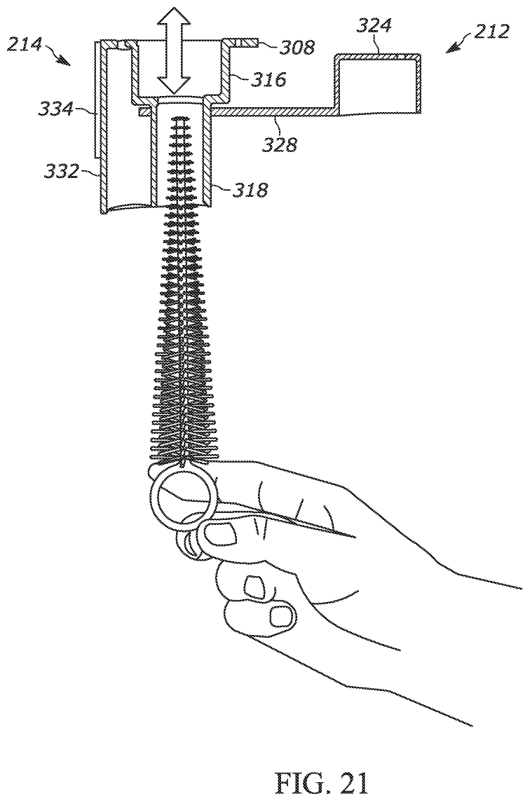

Thus, the pump 200 may quickly be disassembled for cleaning. With reference to FIGS. 16-21, a tube brush of one or more sizes may be inserted within the tubes and cavities of each of the components. When disassembled as described above, a tube brush may be inserted from both ends of the tubes or passageways within the various components to clean all parts of the pump, and particularly the path of the condiment through the pump 200. Thus, the pump 200 may readily be cleaned and cleaned with a reduced amount of effort when compared to prior pump designs.

Moreover, the internal surfaces of the pump 200, and in particular, the fluid flow path through the pump 200, are smooth. There are no nooks, crevices, grooves and the like within the pump 200 that are difficult for the cleaner (e.g., a tube brush) to reach to fully clean the pump 200 components.

Once cleaned, the pump 200 may be readily reassembled (e.g., by reversing the disassembly steps) and used again with the container body 102 and the lid 104 to dispense condiment from a condiment pouch to users.

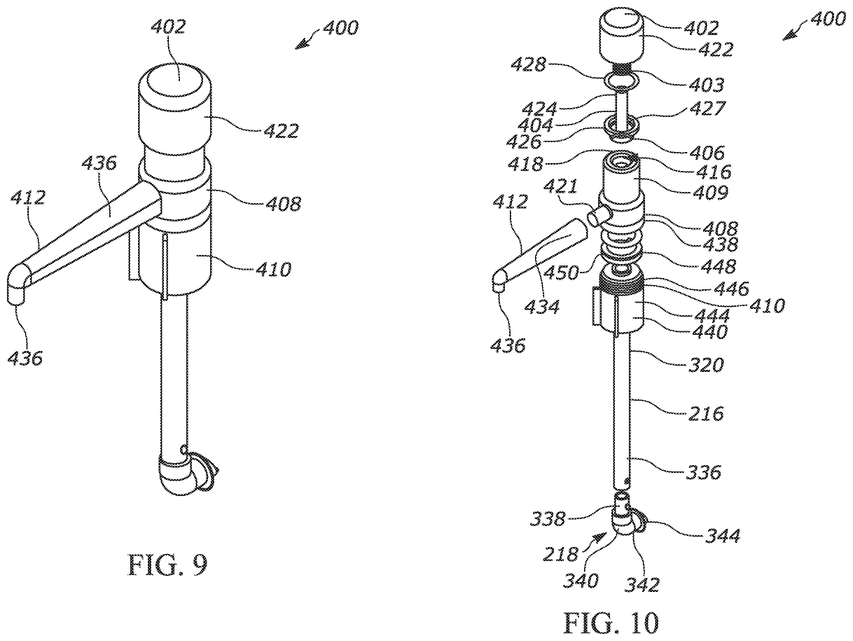

With reference to FIGS. 9-12, a pump 400 according to a second embodiment is shown, with the differences between the pump 200 of the first embodiment highlighted in the description below. For simplicity, the same reference numerals are used where the pump 400 includes the same or similar features as those described in regard to the pump 200 of FIGS. 4-8B.

With reference to FIGS. 9-10, the pump 400 includes a cap 402, a spring 403, a plunger 404, a chamber body 408, a valve retainer 410, a dip tube 216, a bag piercer 218, and a spout 412.

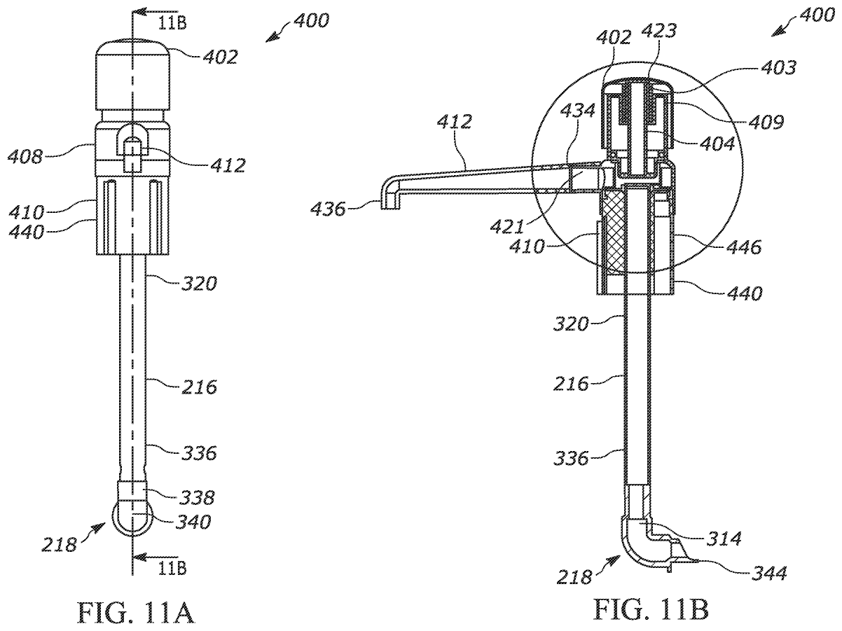

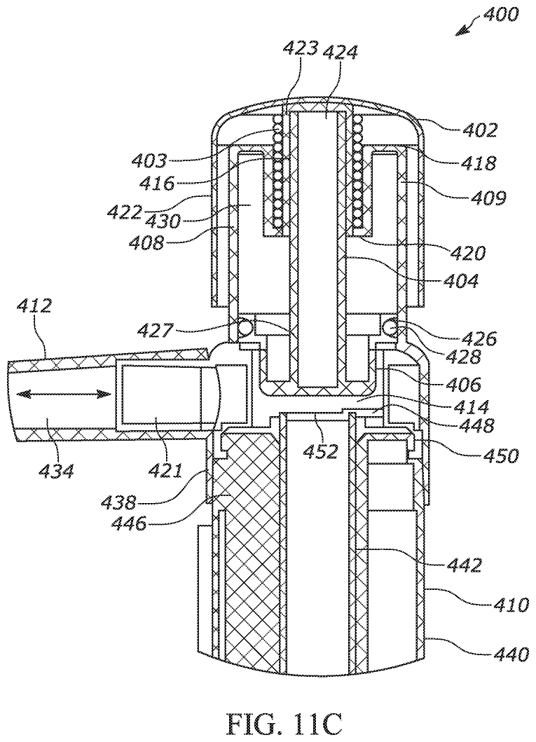

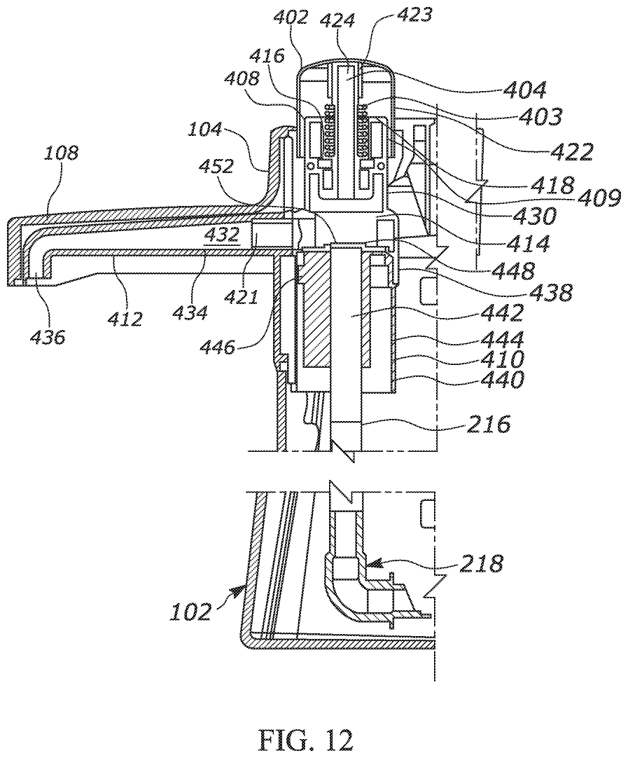

With reference also to FIGS. 11A-12, the chamber body 408 has a cylindrical body 409 defining a cavity 414 therein. The chamber body 408 forms a hole 416 extending from an upper surface 418 of the chamber body 408. A step 420 extends radially inward from a portion of the chamber body 408 defining hole 416. The chamber body 408 further includes an outlet tube 421 extending through a side portion of the cylindrical body 409 and forming a passageway extending from the cavity 414 of the chamber body 408.

The cap 402 includes a rounded top portion 420 and an outer annular skirt 422 depending from the rounded top portion 410. The cap 402 also includes an inner annular skirt 423 for attaching the plunger 404 thereto. The plunger 404 is a rounded tube having a first end 424 attached to the cap 402. The first end 424 of the plunger 404 may be inserted into the inner annular skirt 423 and secured to the cap 402 by friction fit. In another example, the internal surface of the inner annular skirt 423 includes threads therein. The first end 424 of the plunger 404 may include complementary threads for screwing the first end of the plunger 404 into the inner annular skirt 423 to attach the plunger 404 to the cap 402.

The plunger 404 extends from the cap 402, through the hole 416 in the chamber body 408 and into the cavity 414 of the chamber body 408. The second end 427 of the plunger includes or is attached to a plunger head 406. In one example, the plunger head 406 is integrally formed with the plunger 404, for example by injection molding. The plunger head 406 is disk shaped and includes an annular groove 426 about its radial outer surface. A seal 428, such as and O-ring, may be positioned within the annular groove 426. The seal 428 contacts an internal surface 430 of the cylindrical body 409 defining the cavity 414 and may form an airtight seal. As the plunger head 406 moves within the cylindrical body 409, the seal 428 remains in contact with the internal surface 420 of the cylindrical body.

The spring 403 is positioned about the inner annular skirt 423 of the cap 402. The spring 403 extends between the rounded top portion 420 of the cap 402 into the hole 416 of the chamber body 408, and to the step 420 within the hole 416 of the chamber body 408. The spring 403 exerts a force on the cap 402 and the chamber body 408 forcing the cap 402 away from the chamber body 408. The cap 402 is thus biased upward by the spring 403. The cap 402 is forced upward by the spring 403 until the plunger head 406 contacts the upper portion of the chamber body 408, e.g., the portion of the chamber body 408 forming the hole 416.

The spout 412 is a tube defining an internal passageway 432 from an attachment end 434 to the dispensing end 436. The attachment end 434 may be attached to the outlet tube 421, for example, by extending the outlet tube 421 into the attachment end 434 of the spout 412. The spout 412 may thus be secured to the chamber body 408 by a friction fit. In other examples, the spout 412 may snap onto the outlet tube 421. For example, the outlet tube 421 may include one or more projections configured to extend into a detent or hole in the spout 412. The dispensing end 436 may be curved downward to direct the condiment traveling along the passageway 432 of the spout 412 downward as it exits the spout 412 and is dispensed to the user.

The internal surface 430 of the lower end 438 of the cylindrical body 409 of the chamber body 408 includes threads for attaching the chamber body 408 to the valve retainer 410. The valve retainer 410 includes a cylindrical body 440 having a hole 442 extending longitudinally through the cylindrical body 440. The outer surface 444 of the upper end 446 of the cylindrical body 440 includes threads that engage the threads of the lower end 438 of the chamber body 408. Thus, the upper end 446 of the valve retainer 410 may be screwed into the lower end 438 of the chamber body 408. A seal 439, such as an O-ring or rubber gasket, may be positioned between the chamber body 408 and the valve retainer 410 to provide an airtight sealed connection. A one-way valve 448 may also be positioned between the valve retainer 410 and the chamber body 408. For example, the valve 448 may include a cylindrical rim 450 and a flap 452 hingedly attached thereto. The flap 452 may be configured to rotate upward and into the cavity 414 of the chamber body 408 to create an opening in the valve similar to the flap 324 of valve 212 described above. The flap 452 may be inhibited from rotating downward into the valve retainer 410, thus, closing the flap 452 against the cylindrical rim 450 in response to an increase in pressure in the cavity 414 of the chamber body 408. The cylindrical rim 450 may extend downward over the upper end 446 of the valve retainer 410 such that when the chamber body 408 is attached to the valve retainer 410, the cylindrical rim 450 is secured between the valve retainer 410 and the cylindrical body 408.

The dip tube 216 may be inserted into the hole 442 of the valve retainer 410. The dip tube 216 may be secured to the valve retainer 410 by a friction fit. The bag piercer 218 may attach to the lower end 336 of the dip tube 216 as described in regard to the pump 200.

The valve retainer 410 may include ribs 334 extending from the outer surface 444 of the cylindrical body 440. The ribs 334 may engages the ribs 160, 162 of the container body 102 to secure the pump 400 to the container body 102 as described above in regard to the pump 200 and shown in FIG. 13.

The pump 400 operates similarly to the pump 200 described above. In operation, the bag piercer 218 may be inserted into a condiment bag or pouch. The cap 402 and a portion of the chamber body 408 may be inserted through hole 170 in the lid 104 of the condiment dispensing device 100. The lid 104 may be placed on the container body 102. The cap 402 may be pressed downward and released to pump the condiment from the condiment pouch, through the bag piercer 218, up the dip tube 216, into the chamber body 408, out the outlet tube 421 of the chamber body 408, along the spout 412, and out the dispensing end 436 of the spout 412 to the user.

Similar to the pump 200, pressing the cap 402 downward causes the plunger head 406 and seal 428 to move downward within the cavity 414 of the chamber body 408. This movement decreases the volume of air in the cavity 414 of the chamber body 408, thus increasing the pressure within the cavity 414. Since valve 448 is a one-way valve, an increase in pressure in the cavity 414 forces the valve 448 closed. The air or condiment within the cavity 414 is thus forced out of the cavity 414 through the outlet tube 412, spout 412, and dispensing end 436 of the spout 412 to the user. When the cap 402 is released, the spring 403 forces the cap 402 upward, drawing the plunger head 406 and the seal 428 upward within the cavity 414, thus increasing the size of the cavity 414. This increase in volume of the cavity 414 reduces the pressure in the cavity 414, opening the one-way valve 448 and drawing the condiment from the condiment pouch, up the dip tube 216 and into the cavity 414 of the chamber body 408. Thus, repeatedly pressing the cap 402 downward and releasing the cap 402 (or allowing the cap 402 to move upwards) draws the condiment out of the condiment pouch and out the dispensing end 436.

The pump 400 may also be easily disassembled for cleaning. The spout 412 may be removed from the chamber body 408 by applying a force to pull the spout 412 from the outlet tube 421. The valve retainer 410 may be unscrewed from the valve body 308. The dip tube 216 may be withdrawn from the valve retainer 410 by applying a force to pull the dip tube from the valve retainer 410. The hag piercer 218 may be removed from the dip tube 216 by removing the protrusions of the bag piercer 218 from the holes in the lower end 336 of the dip tube 216. The cap 402 may be unscrewed from the plunger 404, separating the cap 402, the plunger 404 and the chamber body 408. Once separated, the components of the pump 400 may be cleaned by inserting the components into a dishwasher and/or by hand washing. Disassembly of the pump 400 allows all internal surfaces of the pump components to be easily accessed, for example, by a tube brush. Thus, the pump 400 may be easily and more fully cleaned, reducing the risk of contamination within the pump 400. Once cleaned the pump 400 may be reassembled and used to dispense condiment to users.

Uses of singular terms such as “a,” “an,” are intended to cover both the singular and the plural, unless otherwise indicated herein or clearly contradicted by context. The terms “comprising,” “having,” “including,” and “containing” are to be construed as open-ended terms. It is intended that the phrase “at least one of” as used herein be interpreted in the disjunctive sense. For example, the phrase “at least one of A and B” is intended to encompass A, B, or both A and B.

While there have been illustrated and described particular embodiments of the present invention, those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

1. A condiment dispensing pump system comprising:
a valve chamber;
a valve retainer including a first portion defining a valve cavity and a second portion for coupling to an inlet flow path;
a one-way valve removably insertable into the valve cavity, the one-way valve including a tether portion coupled to the second portion of the valve retainer such that the one-way valve is removable from the valve cavity while still tethered to the valve retainer;
a spout having a first end fluidly coupled to the valve cavity and a second end opposite the first end; and
a dispensing nozzle removably attached to the second end of the spout, the dispensing nozzle tethered to the spout tube such that when the dispensing nozzle is detached from the second end of the spout the dispensing nozzle remains tethered to the spout tube.

2. The condiment dispensing pump system of claim 1 wherein the valve chamber includes protrusions extending therefrom and the valve retainer defines keyhole slots for receiving the protrusions to removably connect the valve chamber and the valve retainer.

3. The condiment dispensing pump system of claim 1 wherein entire pump system is dishwasher safe.

4. The condiment dispensing pump system of claim 1 wherein the dispensing nozzle is composed of a flexible material.

5. The condiment dispensing pump system of claim 1 wherein the cavity has an internal wall that is smooth.

6. The condiment dispensing pump system of claim 1, wherein the one-way valve is movable between an installed position and a removed position, the installed position having the one-way valve located in the valve cavity and the removed position having the one-way valve outside of the valve cavity, but coupled to the valve retainer via the tether portion.

7. The condiment dispensing pump system of claim 1 further comprising a pump chamber extending from the valve chamber.

8. The condiment dispensing pump system of claim 7 further comprising a pumping cap movable along the pump chamber between a first position and a second position.

9. A condiment dispensing pump system comprising:
a valve chamber;
a pump chamber having a length extending from the valve chamber;
a valve retainer including a first portion defining a valve cavity fluidly coupled to the pump chamber;
a one-way valve positioned in the valve cavity;
a spout having a first end fluidly coupled to the valve cavity and the pump chamber; and
a pumping cap movable along at least a portion of the length of the pump chamber between a first position and a second position to force condiment from the valve cavity through the spout.

10. The condiment dispensing pump system of claim 9 further comprising a guide ring, the guide ring removably coupled to the pumping cap and movable along at least a portion of the length of the pump chamber with the pumping cap.

11. The condiment dispensing pump system of claim 9 further comprising a sealing collar removably coupled to the pump chamber, the sealing collar having a gasket that engages with an interior surface of the pumping cap such that the pumping cap moves relative to the sealing collar.

12. The condiment dispensing pump system of claim 9 wherein the spout is integral with the pump chamber.

13. The condiment dispensing pump system of claim 9 further comprising a spring, the spring engaging the valve chamber to bias the pumping cap away from the valve chamber.

14. The condiment dispensing pump system of claim 9, wherein the valve chamber includes protrusions extending therefrom and the valve retainer defines keyhole slots for receiving the protrusions to removably connect the valve chamber and the valve retainer.

15. The condiment dispensing pump system of claim 9 wherein the one-way valve is movable between an installed position and a removed position, the installed position having the one-way valve located in the valve cavity and the removed position having the one-way valve outside of the valve cavity, but coupled to the valve retainer via a tether portion of the one way valve.

16. A condiment dispensing device comprising
a housing having a bottom and one or more walls extending therefrom, the one or more walls including an inner surface having a plurality of housing ribs extending therefrom; and
a pump system, the pump system including a plurality of pump ribs extending therefrom configured to cooperate with the housing ribs to affix the pump system to the inner surface, the pump ribs slidably engaging the housing ribs to permit the pump system to be removed from the housing,
the pump system including:
a valve chamber,
a pump chamber,
a valve retainer including a first portion defining a valve cavity fluidly coupled to the pump chamber,
a one-way valve,
a spout having a first end fluidly coupled to the valve cavity and the pump chamber, and
a pumping cap.

17. The condiment dispensing device of claim 16 wherein the one-way valve is movable between an installed position and a removed position, the installed position having the one-way valve located in the valve cavity and the removed position having the one-way valve outside of the valve cavity, but coupled to the valve retainer via a tether portion of the one way valve.

18. The condiment dispensing device of claim 16 wherein the pump chamber has a length extending from the valve chamber and the pumping cap is movable along at least a portion of the length of the pump chamber between a first position and a second position to force condiment from the valve cavity through the spout.

19. The condiment dispensing device of claim 16 further comprising a dispensing tip having a first end attached to a dispensing end of the spout, the dispensing tip further connected to the spout by a tether.

20. The condiment dispensing device of claim 16 wherein the dispensing nozzle is composed of a flexible material.

21. The condiment dispensing device of claim 16 wherein the pump system is dishwasher safe.

22. The condiment dispensing device of claim 16 wherein the valve chamber includes protrusions extending therefrom and the valve retainer defines keyhole slots for receiving the protrusions to removably connect the valve chamber and the valve retainer.
